(19) United States
(12) Patent Application Publication
(10) Pub. No.: US 2013/0039574 A1
(43) Pub. Date: Feb. 14, 2013

(54) SYSTEM AND METHOD FOR SEGMENTING WATER, LAND AND COASTLINE FROM REMOTE IMAGERY

(71) Applicants: James P. McKay, New Orleans, LA (US); Cheryl Ann Blain, Slidell, LA (US); Robert S. Linzell, Carriere, MS (US)

(72) Inventors: James P. McKay, New Orleans, LA (US); Cheryl Ann Blain, Slidell, LA (US); Robert S. Linzell, Carriere, MS (US)

(21) Appl. No.: 13/541,951

(22) Filed: Jul. 5, 2012

Related U.S. Application Data
(60) Provisional application No. 61/521,453, filed on Aug. 9, 2011.

(51) Int. Cl. G06K 9/40

(52) U.S. Cl. 382/167

(57) ABSTRACT

System and method for detecting a smooth/rough boundary from an aerial image to solve the problem of isolating image features without access to the subject of the image. The system and method convert the image to gray scale, edge pad the converted image, calculate an image entropy based on a distribution of local entropy across the padded, converted image, threshold the image entropy to binarize the padded, converted image, clean noise, and close defects and voids by mathematical morphologically opening and closing the binarized image, and detect the smooth/rough boundary of the opened/closed binarized image as a gradient across the pixels of the opened/closed binarized image resulting in a single pixel width edge. The single pixel width edge can be, for example, provided to numerical prediction models and computer games.

### CROSS-REFERENCE TO RELATED APPLICATIONS

This Application is a non-provisional application claiming priority to provisional application 61/521,453 filed on Aug. 9, 2011, under 35 USC 119(e), incorporated in its entirety by reference.

### BACKGROUND

Methods and systems disclosed herein relate generally to automated detection and extraction of features in remotely sensed imagery, including water and shorelines. Methods such as, for example, information encoded in multispectral imagery to separate the differences in reflectivity between different surfaces, such as water and land, have limitations, such as when only visual spectrum imagery is available. In another method the image is segmented based on differences in color, hue, saturation or intensity between the features of interest. These methods require the active input of a trained analyst to define the characteristics of the regions of interest. If only one image band is available, as in the case of grayscale imagery, or the features of interest are such that even a trained analyst has difficulty in defining the criteria for segmenting the image, automated, unsupervised (or minimally supervised), image classification schemes can use high resolution information encoded in a single channel image to segment it into finer blocks than a human can segment it. Segmentation by image clustering, the location and definition of regions of similar characteristics, can use K-Mean or ISODATA techniques, but these techniques require significant operator input in the setup phase, significant computation time, and have difficulty identifying geometrically straight features. The Syneract method can reduce the need for operator input but is slow and has generally been used in segmenting land use and vegetation rather than in developing a shoreline. Texture analysis is a method by which images can be segmented by breaking them down into fundamental units, or tokens, or by comparing statistics of image “roughness” based on frequency domain transformation, moment-based segmentation, or both Shannon and non-Shannon entropy, or a combination of techniques.

Image entropy is a measure of the local variance in the image data which can be used to aid in image enhancement. Methods have been developed using image entropy, in combination with other information, in the semi-supervised analysis of remotely sensed images, including in the location and extraction of water points. However, what is needed is an entropy based technique to quickly segment water and land with minimal supervision and without requiring any information in addition to that which is available in a single band image (i.e. a grayscale image).

### SUMMARY

The system and method of the present embodiment can use Shannon entropy to automatically segment water from land in images of rivers or coastal regions, and to locate the interface between the two, the coastline. The method requires little operator setup, and no information other than that contained in a single channel (i.e. grayscale) image. High resolution imagery from any source can be used, including publically available sources such as, for example, but not limited to, GOOGLE EARTH® or TERRASERVER®, with no a priori requirements as to image format, size, color space, or sensor.

The present embodiment can provide an automated method by which an orthorectified aerial or satellite image of a river may be segmented into areas showing land and areas showing water and the interface between them (the coastline) can be determined and exported in georeferenced coordinates. This information can be used to develop a mesh of the river for numerical modeling. This method is designed to be independent of image source, sensor used, image format, image size or color space and to require minimal input from an operator.

The method exploits the fact that in imagery of coastal plain rivers winding through a vegetated or built environment, there is a clear difference in the roughness of the surface of the water and the roughness of the vegetated or built environment surrounding it. This difference is intuitively obvious to a human observer, allowing a human to perceive the river regardless of whether the imagery is in true color, false color, IR, grayscale or any other colorspace. Roughness in an image is represented by the local variance in the image color or gray level and can be expressed in several forms. Shannon entropy is a metric lends itself to classifying this sort of image, but it is not required to use Shannon entropy. There are several other methods of calculating the local variability of the image which may be employed without altering the fundamental concept or procedure.

The method of the present teachings for detecting a smooth/rough boundary in an aerial image can include, but is not limited to including, the steps of obtaining, tiling, and georeferencing the aerial image, the aerial image being of a pre-selected resolution, converting the tiled and georeferenced satellite image to gray scale, edge padding the converted image, calculating the distribution of the local entropy across the padded, converted image, thresholding the image entropy to binarize the padded, converted image, performing the mathematical morphology operations of opening and closing the binarized image to clean noise and close defects and voids, and detecting the smooth/rough boundary of the opened/closed, binarized image as a gradient across the pixels of the opened/closed, binarized image resulting in a single pixel width edge which can be converted into Earth-based coordinates using the available georeferencing information. The described image processing method allows unsupervised and automatic classification and extraction of water and shoreline locations from imagery from arbitrary sources. This removes the significant restriction of other automatic methods of being tied to one source, format or sensor or else requiring significant input from a trained operator.

### BRIEF DESCRIPTION OF THE DRAWINGS

FIG. 1 is a photographic image of the Pearl River, Louisiana, obtained from GOOGLE EARTH®;

FIG. 2 is a table of intensity levels and image padding;

FIG. 3 is a pictorial representation of the distribution of Shannon entropy calculated from the image date of the image depicted in FIG. 1 using equation (1);

FIG. 4 is a pictorial representation of the thresholded and binarized data of the image data of FIG. 3;

FIG. 5 is a pictorial representation of the morphological closing of an image with a small hole;

FIG. 6 is a pictorial representation of the morphological opening of an image with a small “speckle”;

FIG. 7 is a pictorial representation of the image data of FIG. 4 after the basic mathematical morphology operations of closing and opening have been applied;

FIG. 8 is a pictorial representation of edge pixels, shown in red, superimposed on the original image from FIG. 1;

FIG. 9 is a flowchart of the method of the present embodiment; and

FIG. 10 is a schematic block diagram of the system of the present embodiment.

### DETAILED DESCRIPTION

The problems set forth above as well as further and other problems are solved by the present teachings. These solutions and other advantages are achieved by the various embodiments of the teachings described herein below.

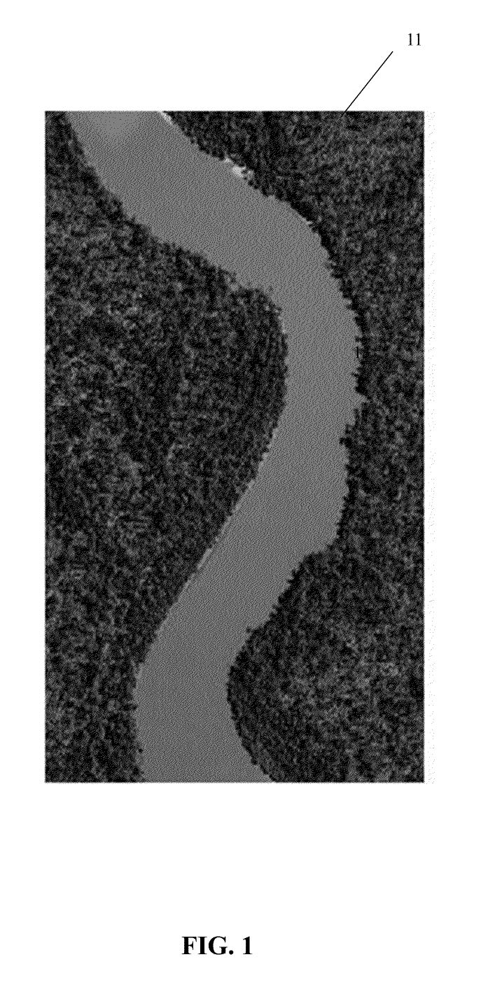

Referring now to FIG. 1, original image 11 must be obtained from, for example, but not limited to, GOOGLE EARTH®. Original image 11 must be of high enough resolution that the rough surface of the land can be readily observed. This required resolution will vary depending on the location of the area of interest but it will generally be in the range of one to three meters per pixel. There must be sufficiently defined features such that the location of two points, both in image coordinates and in geographic coordinates (i.e. UTC or latitude/longitude), is known precisely. This is necessary to map the extracted data back to Earth coordinates by georeferencing which is necessary if the edge data are to be used in a realistic Earth-based model. If there is not a single image covering the area of interest, tiling might be required to assemble a number of small images into one large, continuous image.

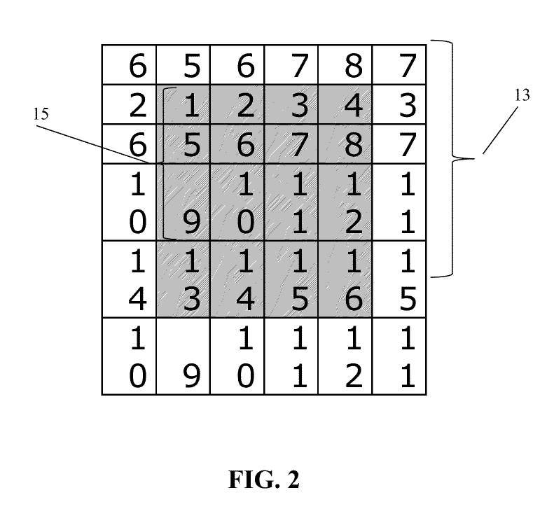

Referring now to FIG. 2, original image 11 (FIG. 1) is converted to grayscale values, if needed, by converting gamma values to intensity and then padding them by adding an extra set of mirrored pixels surrounding the grayscale image. This allows centered statistics to be calculated along the edges of original image 11 (FIG. 1) with no data loss. Values from original image 11 are shown by intensity levels depicted in gray cells 15. Clear cells 13 represent mirrored image padding added around the edges of original image 11 (FIG. 1).

For every pixel in original image 11 (FIG. 1), local Shannon entropy is calculated for the nine pixel box surrounding, and including, the pixel of interest. Shannon entropy is defined as

$$H ( X ) = - {\sum }_{i = 1}^{n} p ( {x}_{i} ) {log}_{2} p ( {x}_{i} ) \qquad ( 1 )$$

where H is the entropy of the gray level X, in the region of interest, with discreet values x₁ . . . xₙ where n is the number of possible gray levels, and p is the probability mass function of X.

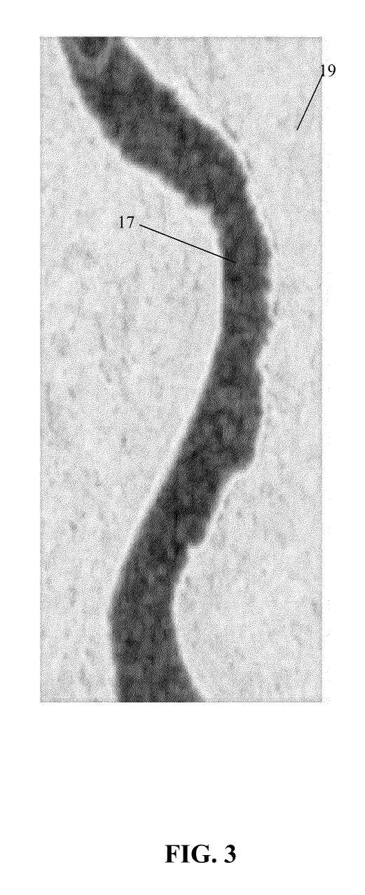

Referring now to FIG. 3, the padded pixels (clear cells 13 (FIG. 2)) are then discarded and the Shannon entropy is plotted for original image 11 (FIG. 1). Dark colors 17 represent low entropy values (smooth regions) while light colors 19 represent high entropy values (rough regions).

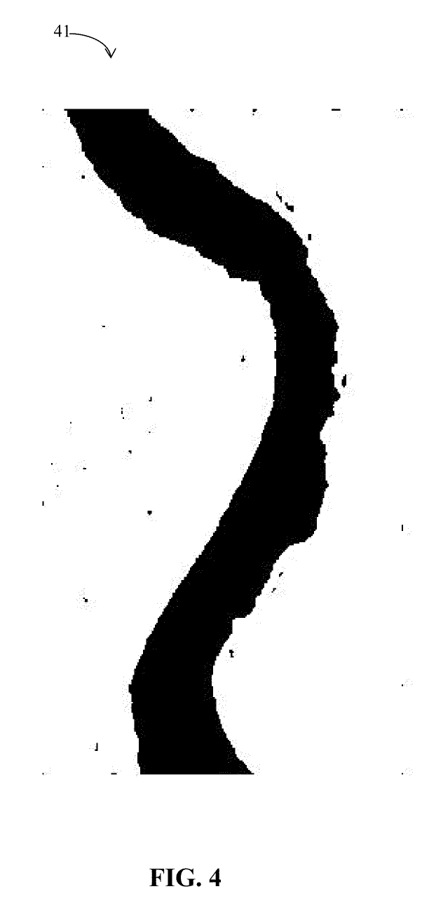

Referring now to FIG. 4, binarized image 41 is created by thresholding such that all pixels with gray levels greater than a preselected amount, for example, but not limited to, one half of the maximum gray level in the entire image, are set to one and all others are set to zero.

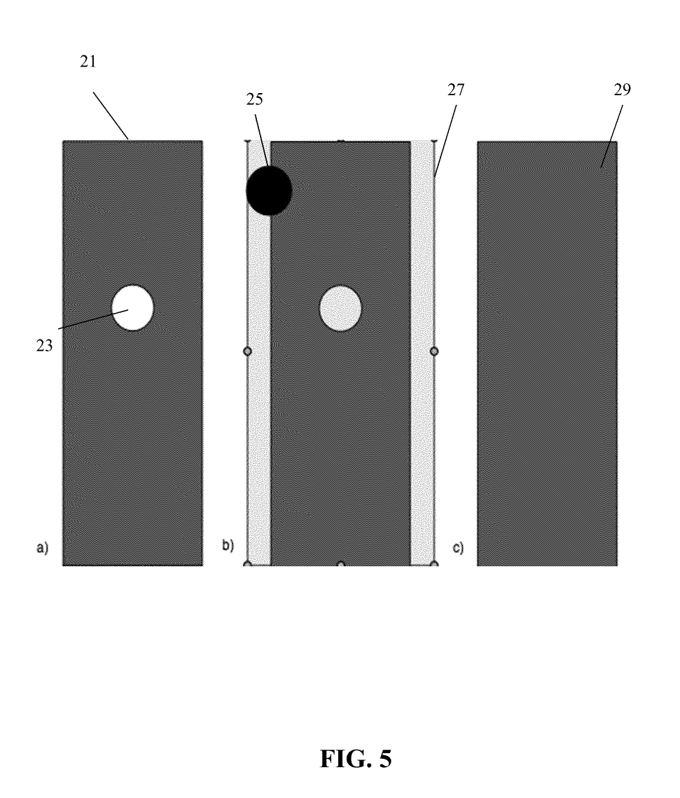

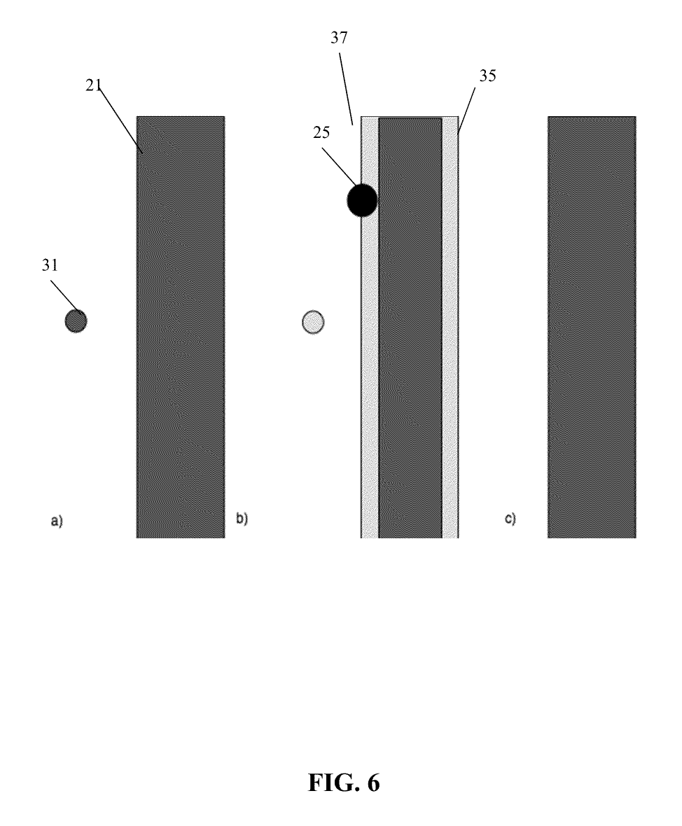

Referring now to FIGS. 5 and 6, the image is processed using two of the basic operations of mathematical morphology—dilation and erosion. These are operations whereby a binary image is acted upon by a structuring element, for example, but not limited to, a circular element. In erosion, pixels are removed from a binary structure equivalent to those masked by the structuring element with the element center moving along the edges of the original structure. Dilation is the opposite operation. These form the basis of the operator pairs of closing and opening. Closing involves dilating and then eroding an image while opening involves eroding and then dilating an image. Closing serves to remove, or close, any small holes in the image while opening serves to despeckle, or remove noise from the image.

In FIG. 5, element (a) represents river segment 21 spanning from the bottom to the top of the image frame. Hole 23 can represent, for example, a small island or an image artifact. In element (b), image dilating is shown by moving structuring element 25 around the edges of the image which can expand the element by an amount shown in area 27. In element (c), the image shown in element (b) is eroded by structuring element 25, removing area 27 from around edge 31. As there is no longer an edge where the hole was, this returns the element (a) with the small hole removed, or closed.

In FIG. 6, element (a) represents river segment 21 spanning from the bottom to the top of the image frame. Region 31 can represent, for example, an isolated smooth area such as a pond or mowed field or an image artifact such as a speckle. In element (b) image eroding is shown by moving structuring element 25 around all edges in the image which can shrink the elements by the amount shown in area 35. In element (c), the image shown in element (b) is dilated by structuring element 25, adding area 35 around edge 37. As there is no longer an edge where region 31 was, this returns element (a) with region 31 removed. The image has been opened.

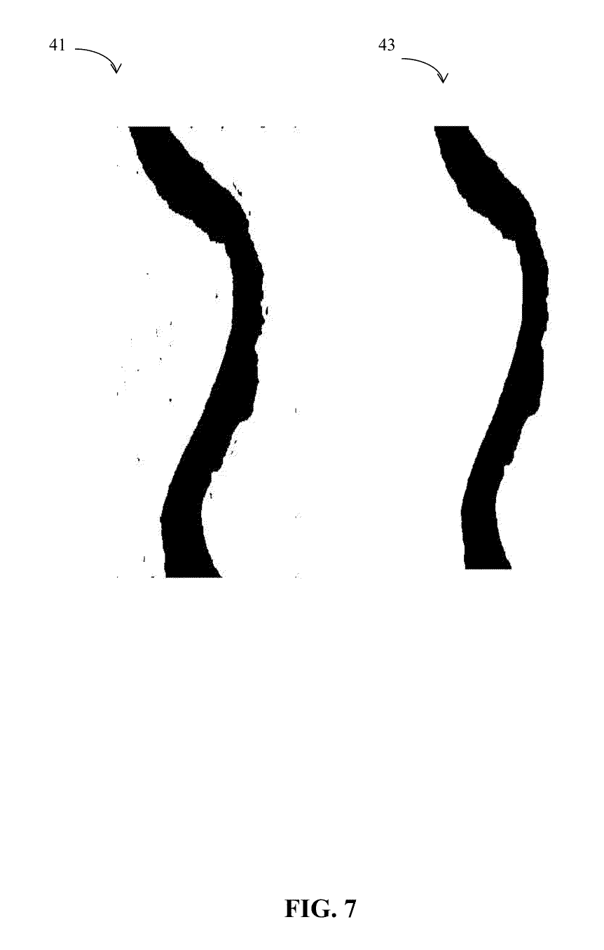

Referring now to FIG. 7, the results of applying these two morphological operations to binarized image 41 (FIG. 4) are shown. The locations of the black (low entropy) pixels can be returned as the location of the water.

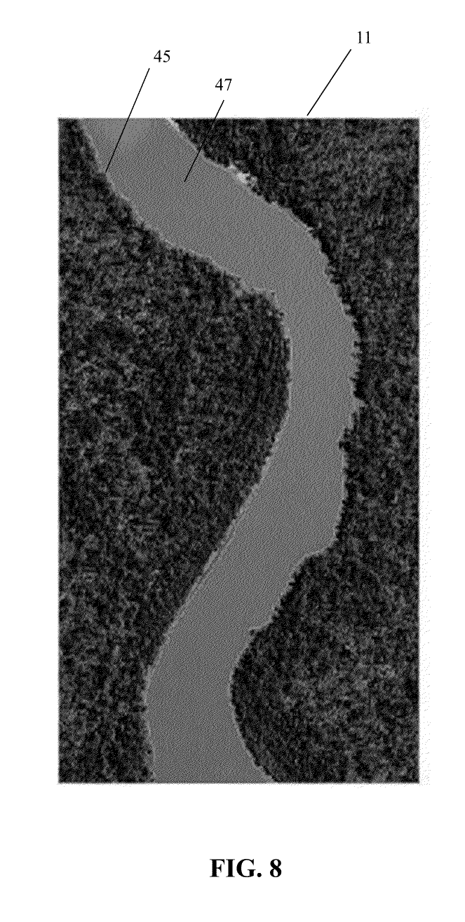

Referring now to FIG. 8, river edges 45 can be located by finding the interface between the low entropy (water) and high entropy (land) pixels by examining the local gradient. By referencing two distinct points in the image where both image coordinates (row and column) and geographic coordinates (UTC or latitude and longitude) are known, locations of edge 45 and water 47 can be converted into georeferenced coordinates for use in a numerical model.

In an illustrative embodiment, MATLAB® can be used to prepare software code that implements the preceding system. The MATLAB® Imaging Toolkit routines can optionally be used, and the software code can be ported to any programming language using standard library functions.

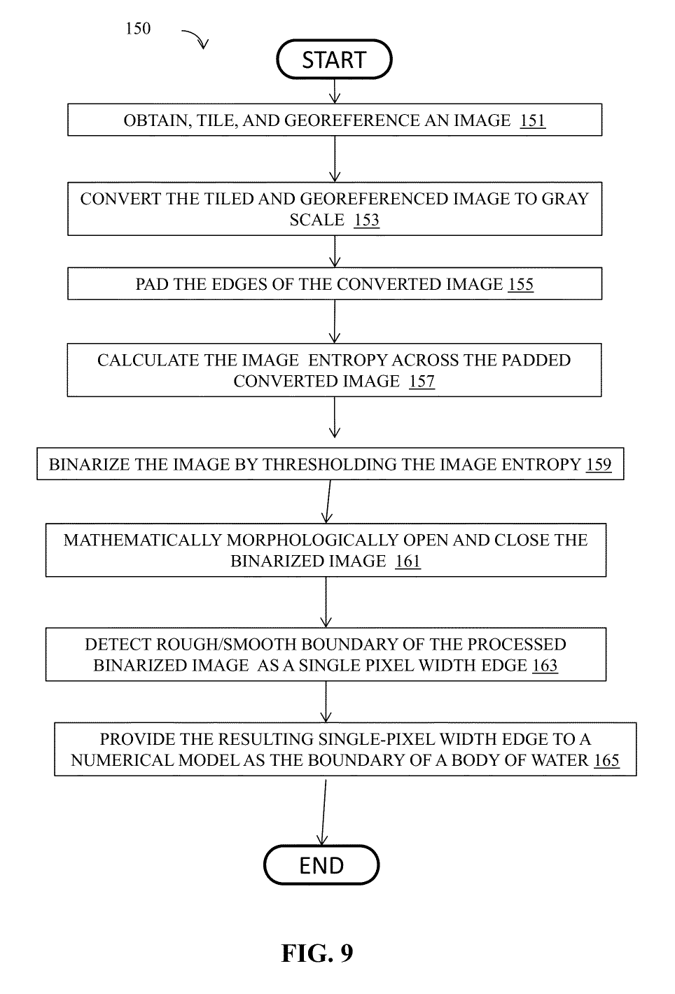

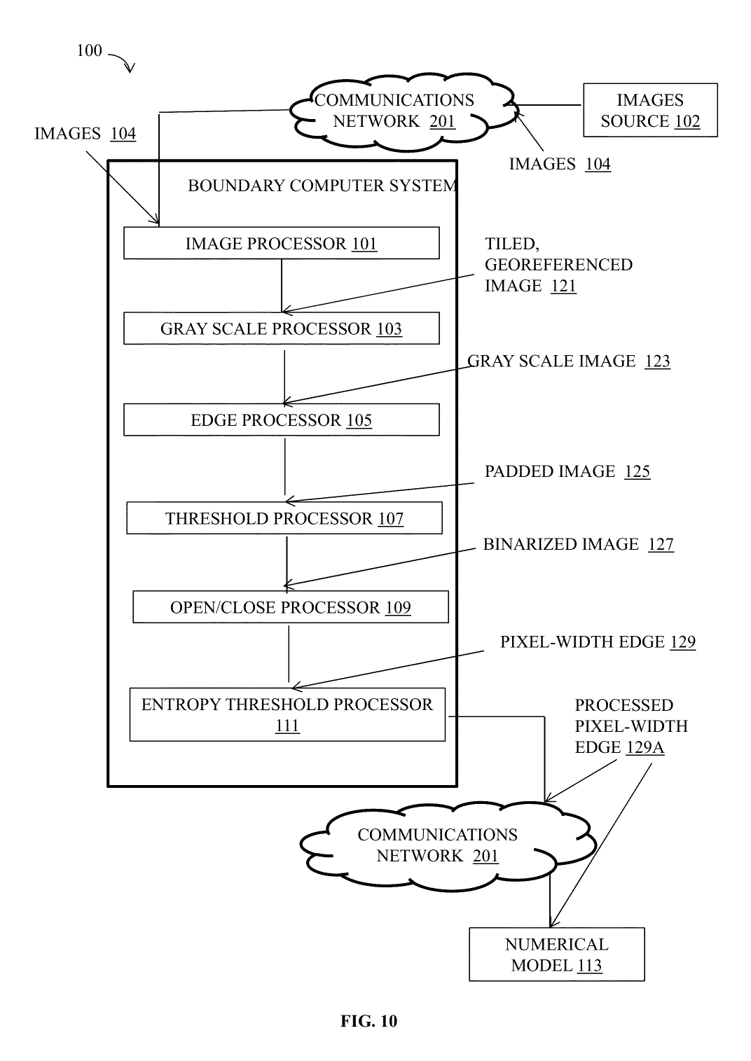

Referring now to FIG. 9, method 150 of the present embodiment for detecting a smooth/rough boundary in an image can include, but is not limited to including, the steps of obtaining, tiling, and georeferencing 151 the image, converting 153 the tiled and georeferenced image to gray scale, edge padding 155 the converted image, calculating 157 the distribution of the local entropy across the padded, converted image, thresholding the image entropy to binarize 159 the padded, converted image, mathematical morphologically opening and closing 161 the binarized image to clean noise and close defects and voids, and detecting 163 the smooth/rough boundary of the opened/closed, binarized image as a gradient across the pixels of the opened/closed, binarized image entropy resulting 165 in a single pixel width edge, and converting the single pixel width edge into Earth-based coordinates. The aerial image is optionally tiled and georeferenced, and of a pre-selected resolution. Images 104 (FIG. 10) including the aerial image can be gathered from, for example, but not limited to, a satellite, an aircraft, a rocket, a blimp, or a building. The aerial image can be, for example, high enough resolution to differentiate between smooth and rough surfaces at a nine-pixel level, for example, two meters/pixel or higher. The aerial image can also be orthorectified. The step of converting the single pixel width edge can be accomplished using the available georeferencing information.

Referring now to FIG. 10, computer system 100 of the present embodiment for detecting a smooth/rough boundary in an image can include, but is not limited to including, image processor 101 obtaining images 104 from, for example, but not limited to, communications network 201 connected to image sources 102, which are optionally tiled and georeferenced, and optionally of a pre-selected resolution. System 100 can also include gray scale processor 103 converting image 121 to gray scale, edge processor 105 padding gray scale image 123 and calculating the distribution of the local entropy across the padded image 125, threshold processor 107 thresholding the image entropy to create binarized image 127, open/close processor 109 mathematical morphologically opening and closing binarized image 127 to clean noise and close defects and voids, entropy threshold processor 111 detecting the smooth/rough boundary of the opened/closed, binarized image as a gradient across the pixels of the binarized image 127 resulting in single pixel width edge 129 which can be converted into Earth-based coordinates, optionally using georeferencing information, and provided to numerical model 113 through, for example, but not limited to, communications network 201.

Embodiments of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. In an exemplary embodiment, the software for the system is written in Fortran and C. The system operates on a computer having a variable number of CPUs. Other alternative computer platforms can be used. The operating system can be, for example, but is not limited to, WINDOWS® or LINUX®.

The present embodiment is also directed to software for accomplishing the methods discussed herein, and computer readable media storing software for accomplishing these methods. The various modules described herein can be accomplished on the same CPU, or can be accomplished on a different computer. In compliance with the statute, the present embodiment has been described in language more or less specific as to structural and methodical features. It is to be understood, however, that the present embodiment is not limited to the specific features shown and described, since the means herein disclosed comprise preferred forms of putting the present embodiment into effect.

Referring again primarily to FIG. 9, method 150 can be, in whole or in part, implemented electronically. Signals representing actions taken by elements of system 100 (FIG. 10) and other disclosed embodiments can travel over at least one live communications network 201 (FIG. 10). Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

Although the present teachings have been described with respect to various embodiments, it should be realized these teachings are also capable of a wide variety of further and other embodiments.

What is claimed is:

1. A method for detecting a smooth/rough boundary in a tiled and georeferenced image comprising the steps of:
converting the tiled and georeferenced image to gray scale;
edge padding the converted image;
calculating an image entropy based on a distribution of local entropy across the padded, converted image;
thresholding the image entropy to binarize the padded, converted image;
cleaning noise, and closing defects and voids by mathematical morphologically opening and closing the binarized image; and
detecting the smooth/rough boundary of the opened/closed binarized image as a gradient across the pixels of the opened/closed binarized image resulting in a single pixel width edge.

2. The method as in claim 1 further comprising the step of:
converting the single pixel width edge into Earth-based coordinates.

3. The method as in claim 2 wherein the step of converting the single pixel width edge comprises the step of:
basing the conversion on georeferencing information.

4. The method as in claim 1 wherein the aerial image comprises a pre-selected resolution.

5. The method as in claim 1 further comprising the step of:
selecting the aerial image from a group of satellite-based images, aircraft-based images, rocket-based images, blimp-based images, and building-based images.

6. The method as in claim 1 wherein the aerial image comprises a high enough resolution to differentiate between smooth and rough surfaces at a nine-pixel level.

7. The method as in claim 1 wherein the aerial image comprises an orthorectified image.

8. The method as in claim 1 further comprising the step of:
providing the single-pixel width edge to a numerical model as the boundary of a body of water.

9. A computer system for detecting a smooth/rough boundary in a tiled and georeferenced image comprises:
a gray scale processor converting the tiled and georeferenced image to gray scale;
an edge processor padding the gray scale image and calculating an image entropy based on a distribution of local entropy across the padded, converted image;
a threshold processor thresholding the image entropy to create a binarized image;
an open/close processor cleaning noise, and closing defects and voids by mathematical morphologically opening and closing the binarized image; and
an entropy threshold processor detecting the smooth/rough boundary of the opened/closed, binarized image as a gradient across the pixels of the binarized image resulting in a single pixel width edge.

10. The system as in claim 9 wherein the entropy threshold processor further comprises computer code for processing the single pixel width edge based on Earth-based coordinates.

11. The system as in claim 10 wherein the entropy threshold processor further comprises computer code for processing the single pixel width edge using georeferencing information.

12. The system as in claim 10 wherein the entropy threshold processor comprises computer code for providing the converted single pixel width edge to a numerical model as the boundary of a body of water.

13. The system as in claim 9 further comprising:
an image processor obtaining the tiled and georeferenced image.

14. The system as in claim 12 wherein the image processor selects the aerial image from a group of satellite-based images, aircraft-based images, rocket-based images, blimp-based images, and building-based images.

15. The system as in claim 12 wherein the aerial image comprises a high enough resolution to differentiate between smooth and rough surfaces at a nine-pixel level.

16. The system as in claim 9 wherein the aerial image comprises a pre-selected resolution.

17. The system as in claim 9 wherein the aerial image comprises an orthorectified image.
